(19) United States
(12) Patent Application Publication
(10) Pub. No.: US 2026/0278812 A1
(43) Pub. Date: Sep. 17, 2026

(54) STATE ESTIMATION APPARATUS AND STATE ESTIMATION METHOD

(71) Applicant: HONDA MOTOR CO., LTD., Tokyo (JP)

(72) Inventors: Masanori Yoshihira, Wako-shi (JP); Tadaaki Hasegawa, Wako-shi (JP)

(21) Appl. No.: 19/543,889

(22) Filed: Feb. 19, 2026

(30) Foreign Application Priority Data
Mar. 17, 2025 (JP) 2025-042250

(51) Int. Cl. G06T 7/246; G06T 7/00; G06T 7/13; G06T 17/20

(52) U.S. Cl. CPC G06T 7/251; G06T 7/0002; G06T 7/13; G06T 17/20; G06T 2207/20072; G06T 2207/20084

(57) ABSTRACT

A state estimation apparatus includes: a target state setting unit that sets a target state of a target object; an acquisition unit that acquires image information representing the target object; a meshing unit that meshes the image information; a graph representation generation unit that represents a meshed image with nodes and edges, assigns information relating to positions of nodes to the nodes, and assigns information indicating relationships between the nodes to edges; a modeling unit that inputs information of an entire mesh into a GNN and models distance dependencies and interactions of the entire mesh with an Attention mechanism; and an estimation unit that estimates region changes of the target object from time-series changes.

### CROSS-REFERENCE TO RELATED APPLICATION

This application claims priority based on Japanese Patent Application No. 2025-042250 filed in Japan on Mar. 17, 2025, the entire contents of which are incorporated herein by reference.

### BACKGROUND OF THE INVENTION

### Field of the Invention

The present invention relates to a state estimation apparatus and a state estimation method.

### Description of Related Art

For example, there is a task of spreading a flexible object such as a vinyl bag and then mounting it to a rigid body such as a plastic bucket. When causing an end effector to perform such a task, the task is performed with primary focus on two-dimensional image processing by determining the attachment state of the vinyl bag to the plastic bucket.

For example, when controlling a robot having a hand, a point cloud is acquired from an image captured by, for example, a depth camera that can also acquire depth information, and this point cloud is input to a trained model to generate a gripping posture (see, for example, Patent Document 1 below).

It has been proposed to cause an object to be gripped by: using a first neural network to generate a set of gripping postures that enable the robot to grip the object from a three-dimensional point cloud of the object; using a second neural network to determine an evaluation of individual grips within the set of gripping postures; and refining individual grips within the set of gripping postures on the basis of at least in part a gradient of the evaluation determined by the second neural network to generate the set of refined gripping postures (see, for example, Patent Document 2 below).
[Patent Document 1] Japanese Unexamined Patent Application, First Publication No. 2022-24952
[Patent Document 2] Japanese Unexamined Patent Application, First Publication No. 2024-109937

### SUMMARY OF THE INVENTION

However, with the technique described in Patent Document 1, with only two-dimensional planar information, it was difficult to accurately capture, for example, curling up, wrinkles, three-dimensional distortion, and deviation from a target state of a flexible object, and it was difficult to accurately determine the state of a target object. With the technique described in Patent Document 2, a high-precision method that performs three-dimensional analysis of an entire region has problems of high computational cost and poor real-time performance.

Aspects according to the present invention have been made in view of the above problems, and an object thereof is to provide a state estimation apparatus and a state estimation method capable of accurately estimating the state of an object and relationships between objects.

In order to solve the above problems and achieve the object, the present invention adopts the following aspects.

(1) A state estimation apparatus according to one aspect of the present invention is a state estimation apparatus for a deformable target object, including: a target state setting unit that sets a target state of the target object; an acquisition unit that acquires image information representing the target object; a meshing unit that meshes the image information; a graph representation generation unit that represents the meshed image with nodes and edges, assigns information relating to positions of the nodes to the nodes, and assigns information indicating relationships between the nodes to the edges; a modeling unit that inputs information of an entire mesh into a GNN (Graph Neural Network) and models distance dependencies and interactions of the entire mesh with an Attention mechanism; and an estimation unit that estimates region changes of the target object from time-series changes.

(2) In the aspect of (1) above, the apparatus may include an area-requiring-detailed-inspection extraction unit that extracts, as an area requiring detailed inspection, a portion where there is a possibility that a state of the target object has not reached the target state based on two-dimensional image information, wherein the acquisition unit may acquire the two-dimensional image information representing the target object and then acquires three-dimensional data of the area requiring detailed inspection extracted by the area-requiring-detailed-inspection extraction unit, and the meshing unit may perform the meshing on the acquired three-dimensional data.

(3) In the aspect of (1) or (2) above, the information relating to positions of the nodes may be information representing at least one of coordinates and curvature, and the information indicating relationships between the nodes may be information representing at least one of inter-node distance, directionality, and difference in normal direction.

(4) In any one aspect of (1) to (3) above, the modeling unit may reduce the number of nodes by utilizing position and curvature information included in the information relating to positions of the nodes on the mesh.

(5) In any one aspect of (1) to (4) above, the graph representation generation unit may represent with a graph representation after passing through a voxel filter.

(6) A state estimation method according to one aspect of the present invention is a state estimation method for a deformable target object, including: a target state setting step of setting a target state of the target object; an acquisition step of acquiring image information representing the target object; a meshing step of meshing the image information; a graph representation generation step of representing the meshed image with nodes and edges, assigning information relating to positions of the nodes to the nodes, and assigning information indicating relationships between the nodes to the edges; a modeling step of inputting information of an entire mesh into a GNN (Graph Neural Network) and modeling distance dependencies and interactions of the entire mesh with an Attention mechanism; and an estimation step of estimating region changes of the target object from time-series changes.

According to the aspects of (1) to (6) above, the state of an object and relationships between objects can be accurately estimated.

### BRIEF DESCRIPTION OF THE DRAWINGS

FIG. 1 is a diagram showing a configuration example of a state estimation system of an embodiment.

FIG. 2 is a diagram showing a configuration example of a target object detection relationship prediction unit.

FIG. 3 is a diagram showing an example of a result of performing segmentation processing on an image captured in a state where a handkerchief with creases and the like exists in a work space, and an example of performing labeling processing.

FIG. 4 is a diagram for explaining a graph representation example and a labeling processing example.

FIG. 5 is a diagram showing a configuration example of a work system including the state estimation system of the embodiment.

FIG. 6 is a diagram showing an area-requiring-detailed-inspection example and a target state example.

FIG. 7 is a diagram showing another area-requiring-detailed-inspection example.

FIG. 8 is an image showing an example of meshing an image of a target object having wrinkles.

FIG. 9 is a diagram for explaining an example of nodes and edges and an example of assigning position embedding to nodes.

FIG. 10 is an image diagram of an example in which position embedding is assigned to nodes.

FIG. 11 is a diagram showing a correspondence example between a mesh graph and a time graph.

FIG. 12 is a diagram for explaining node reduction processing.

FIG. 13 is a diagram for explaining target achievement determination processing.

FIG. 14 is a diagram showing an example of a processing flow of the state estimation apparatus of the embodiment.

FIG. 15 is a flowchart of processing of the state estimation apparatus of the embodiment.

### DETAILED DESCRIPTION OF THE INVENTION

Hereinafter, an embodiment of the present invention will be described with reference to the drawings. In the drawings used for the following description, scales of elements are appropriately changed to make each element recognizable in size.

In all the drawings used for description of the embodiments, elements having the same functions will be referred to by the same reference signs, and repeated description thereof will be omitted.

“On the basis of XX” mentioned in this specification means “based on at least XX” and includes “based on another element in addition to XX.” “On the basis of XX” is not limited to direct use of XX and includes use of results obtained by performing calculation or processing on XX. “XX” is an arbitrary element (for example, arbitrary information).

### Overview

In the present embodiment, by performing the following processing, it is determined whether or not the state of a target object has reached a target state, and the relationship between two objects is estimated.

### (i) Stepwise Specification of Target Achievement Determination Portions (Areas Requiring Detailed Inspection)

Extraction is performed as areas requiring detailed inspection based on two-dimensional image information. An area requiring detailed inspection is, for example, an image region where it is considered that work has not reached a target state.

### (ii) Three-Dimensional Data Acquisition

For the area requiring detailed inspection, high-precision three-dimensional data is acquired by, for example, a depth camera or a three-dimensional scanner, and meshing is performed.

(iii) Mesh Graph Construction

The mesh is represented with nodes and edges, position embedding (coordinates, curvature, etc.) information, which is information relating to positions of nodes, is assigned to the nodes, and relationship embedding (inter-node distance, directionality, difference in normal direction, etc.), which is information indicating relationships between nodes, is assigned to the edges.

### (iv) Analysis by Graph Transformer and Spatiotemporal GNN

A mesh graph including the area requiring detailed inspection is analyzed by Graph Transformer and spatiotemporal GNN (Graph Neural Network). GNN is a type of deep learning model for processing data having a graph structure.

### (v) Multi-Scale Analysis and Attention Mechanism

Multi-scale mesh analysis achieved both global shape grasping and local detailed analysis. Furthermore, by an Attention mechanism, focused evaluation is performed on particularly important nodes (for example, a rim portion of a rigid body that is a target of a flexible object, an edge portion of a bag that is a flexible object, etc.) even within the area requiring detailed inspection, thereby improving accuracy and interpretability.

### <Configuration Example of State Estimation System>

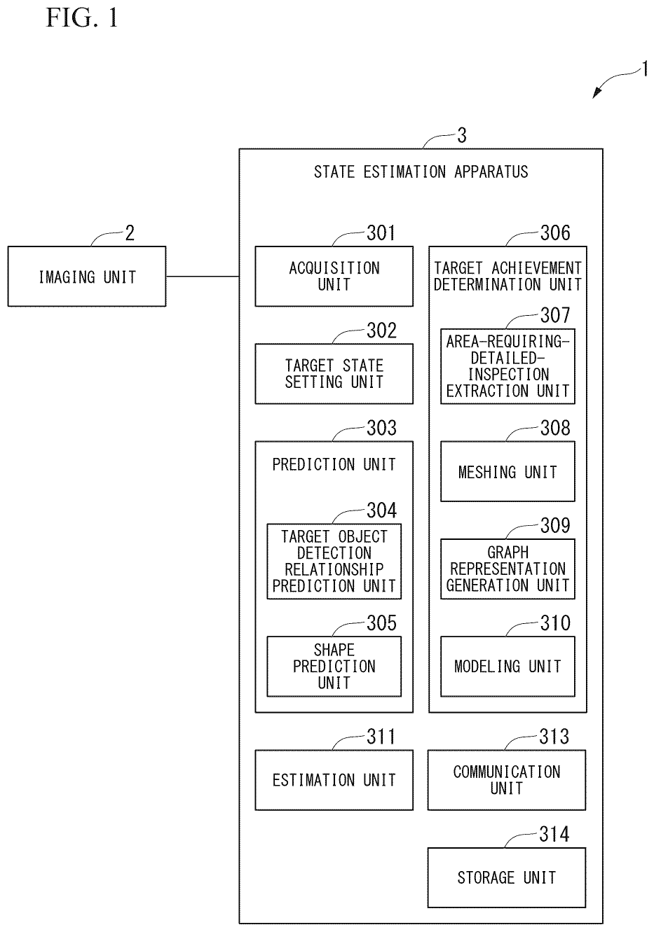

FIG. 1 is a diagram showing a configuration example of a state estimation system of the present embodiment. The state estimation system 1 includes, for example, an imaging unit 2 and a state estimation apparatus 3.

The state estimation apparatus 3 includes, for example, an acquisition unit 301, a target state setting unit 302, a prediction unit 303, a target achievement determination unit 306, an estimation unit 311, a communication unit 313, and a storage unit 314.

The prediction unit 303 includes, for example, a target object detection relationship prediction unit 304 and a shape prediction unit 305.

The target achievement determination unit 306 includes, for example, an area-requiring-detailed-inspection extraction unit 307, a meshing unit 308, a graph representation generation unit 309, and a modeling unit 310.

The state estimation apparatus 3 and the imaging unit 2 are connected by wire or wirelessly.

In the following description, an example will be described in which a target object (first object) is a flexible object such as paper, cloth, or a vinyl bag.

The work content to be performed using a result determined by the state estimation apparatus 3 is, for example, work such as spreading a handkerchief that is a flexible object on a table, or spreading a vinyl bag (first object) that is a flexible object and covering a rim portion of a plastic bucket (second object) by folding a mouth portion of the vinyl bag.

The imaging unit 2 captures an image including an object to be worked on. The imaging unit 2 may include both a two-dimensional camera and a depth camera or a three-dimensional scanner, etc. The imaging unit 2 may be a depth camera that can also obtain depth information, or may be a two-dimensional RGB (red-green-blue) camera and a range finder. The imaging unit 2 captures moving images or still images for each frame. The imaging unit 2 may be installed in a work environment. The number of imaging units 2 may be two or more.

The state estimation apparatus 3 determines whether or not the target object has reached a target state by estimating a position of the target object (first object), a shape of the target object (degree of wrinkles, spread), a posture of the target object, and a relationship and distance between the target object and another object (second object) from an image captured by the imaging unit 2.

The acquisition unit 301 acquires two-dimensional image information captured by the imaging unit 2. The acquisition unit 301 acquires three-dimensional data of an area requiring detailed inspection extracted by the area-requiring-detailed-inspection extraction unit 307.

The target state setting unit 302 sets a target state of the target object. The target state may be stored in the storage unit 314 in advance, or may be obtained by inputting an image and teacher data into a trained model.

The prediction unit 303 predicts a future state in a case where a target state is set and an external force acts. The number of each of the target object detection relationship prediction unit 304 and the shape prediction unit 305 may be plural.

The target object detection relationship prediction unit 304 extracts a target object from a captured image. The target object detection relationship prediction unit 304 estimates a relationship (for example, position, distance, direction, etc.) between the extracted target object and another object. The target object detection relationship prediction unit 304 is, for example, a trained model, and is trained in advance using a captured image as input data and the target object and information indicating a relationship as teacher data.

The shape prediction unit 305 predicts a shape of the target object. The shape prediction unit 305 is, for example, a model, and is trained in advance using data output by the target object detection relationship prediction unit 304 as input data and a shape of the target object as teacher data.

The target achievement determination unit 306 determines whether or not a shape of the target object has reached a target state on the basis of information output by the shape prediction unit 305. The target achievement determination unit 306, for example, calculates a target achievement degree of the two target objects with respect to each other by a pair of nodes using position embedding information of nodes.

The area-requiring-detailed-inspection extraction unit 307, for example, extracts, as an area requiring detailed inspection, a portion where there is a possibility that a state of a flexible object (first object) has not reached a target state based on two-dimensional image information. This “area requiring detailed inspection” refers to, for example, a critical region where it should be determined in detail whether or not a flexible object is correctly covered on a rigid body. In the present embodiment, subsequent three-dimensional detailed analysis is applied only to a portion where an area requiring detailed inspection has been specified (high-precision three-dimensional acquisition to a limited range, not the entire region).

The meshing unit 308 meshes a region of the target object among acquired three-dimensional data.

The graph representation generation unit 309 represents a meshed image with nodes and edges. The graph representation generation unit 309 assigns position embedding information (coordinates, curvature, etc.) to nodes and assigns relationship embedding information (inter-node distance, directionality, difference in normal direction, etc.) to edges. Embedding information is an embedded representation.

The modeling unit 310 analyzes a mesh graph including an area requiring detailed inspection by, for example, Graph Transformer and spatiotemporal GNN. The modeling unit 310 inputs information of an entire mesh into a GNN and models distance dependencies and interactions of the entire mesh with an Attention mechanism. Attention is a mechanism for dynamically identifying where in input data attention should be paid. In Graph Transformer, in order to capture uncovered regions and fitting degree, long-distance dependencies and complex interactions of an entire mesh are modeled with an Attention mechanism. In spatiotemporal GNN, temporal changes are captured, and a process in which a flexible object gradually fits, for example, to a rim portion of another object is considered, and, for example, changes in an uncovered region are dynamically analyzed. Thereby, in the present embodiment, both global shape grasping and local detailed analysis are configured to be achieved by multi-scale mesh analysis. A method for achieving both global shape grasping and local detailed analysis by multi-scale mesh analysis will be described later.

The estimation unit 311 estimates region changes of a target object from time-series changes.

The communication unit 313 outputs an estimated result to an external device (for example, a computer, a smartphone, a tablet terminal, a dedicated device, a robot, etc.).

The storage unit 314 stores models, algorithms, formulas, predetermined values, etc. used by each processing unit.

<Method for Achieving Both Global Shape Grasping and Local Detailed Analysis by Multi-Scale Mesh Analysis>Here, a method for achieving both global shape grasping and local detailed analysis by multi-scale mesh analysis will be described. Processing for achieving both global shape grasping and local detailed analysis by multi-scale mesh analysis is realized, for example, by performing the following processing (I) to (V).

(I) First, the significance of stepwise combination of two-dimensional images and three-dimensional measurement in the present embodiment will be described. When targeting flexible objects or complex shapes, if high-precision three-dimensional measurement is uniformly performed on an entire region, enormous data is generated and analysis requires time. Therefore, in the present embodiment, first, on the basis of a two-dimensional image, an outline of an entire object and a rough positional relationship are captured, and from there, “a portion with a high possibility of not having reached a target state (area requiring detailed inspection)” is extracted. Thereby, according to the present embodiment, rough grasping of the whole is completed with low-cost two-dimensional image processing, and by limiting detailed analysis to a truly necessary range, high precision can be obtained while suppressing computational load.

(II) Next, in the present embodiment, initial shape estimation is performed by image processing that generates images from multiple viewpoints (multi-view). In the present embodiment, when three-dimensional information is insufficient with only a monocular capture of a two-dimensional image, a point cloud of a target object is reconstructed using images from multiple viewpoints. Thereby, according to the present embodiment, correspondence between each pixel (stereo matching, etc.) is performed, and a skeleton of a global three-dimensional model is obtained. Furthermore, according to the present embodiment, based on this initial estimation result, it is possible to further improve accuracy of local scanning and mesh analysis.

(III) Next, in the present embodiment, Graph Transformer is utilized. In the present embodiment, a point cloud or mesh is represented as a graph structure (vertices as nodes, sides as edges), “position embedding information” such as coordinates and curvature is assigned to each node, and “relationship embedding information (distance, direction, etc.)” is assigned to each edge. Graph Transformer has an advantage that it is easy to simultaneously learn “relationships between vertices far apart” and “interactions of nodes densely concentrated locally” using an Attention mechanism. Thereby, according to the present embodiment, it becomes possible to consistently model global and local deformations such as wrinkles, steps, and slight floating on curved surfaces.

(IV) Next, in the present embodiment, detailed analysis of a local mesh is performed. In the present embodiment, when “a location with obviously large distortion” or “a location suspected of not being in close contact” is identified as a result of two-dimensional image analysis or multi-view analysis, only for that region, high-precision three-dimensional scanning or depth camera measurement is performed. In the present embodiment, a finer polygon division and normal estimation are applied to an obtained local mesh, and it is input into Graph Transformer or GNN. Thereby, according to the present embodiment, it is possible to analyze even fine shape differences of several millimeters such as wrinkles, curling, and floating.

(V) Next, in the present embodiment, computational load is reduced by a stepwise approach. In the present embodiment, high-precision scanning over an entire area is avoided, and first “global scale: grasping a target with two-dimensional images or multi-view images” is performed, and then “local scale: three-dimensional measurement only for areas requiring detailed inspection” is performed to appropriately limit data volume. Even when using Graph Transformer, node reduction or sampling is performed so that the number of mesh nodes in an area requiring detailed inspection does not become too large. By such a stepwise flow, according to the present embodiment, it is possible to secure necessary accuracy while maintaining real-time processing or practical speed.

### <Positional Relationship, Achievement of Target State>

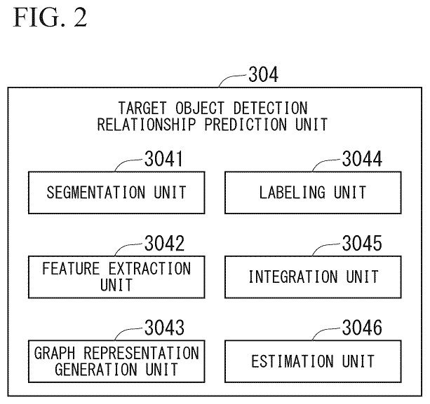

Next, positional relationships between a first object and a second object, achievement of a target state, etc. will be described. FIG. 2 is a diagram showing a configuration example of a target object detection relationship prediction unit.

The target object detection relationship prediction unit 304 includes, for example, a segmentation unit 3041, a feature extraction unit 3042, a graph representation generation unit 3043, a labeling unit 3044, an integration unit 3045, and an estimation unit 3046.

The segmentation unit 3041 includes, for example, a trained semantic segmentation model. The semantic segmentation model may be placed in a cloud or may be stored in a server or the like connected via a network. The segmentation unit 3041 using an acquired image, executes high-precision pixel-level segmentation with, for example, U-Net or DeepLab, etc., and divides the image into a plurality of segments (micro-regions). The segmentation unit 3041, for example, performs fine contour extraction, distinction of fine structures (wrinkles, sagging) on a surface of a flexible object, and clarification of boundaries with a background.

The feature extraction unit 3042 extracts feature amounts such as color, texture, position information, and depth information (as necessary), etc. for each segment.

The graph representation generation unit 3043 forms edges based on features such as proximity, similarity, positional relationship, and contact relationship, with segments as nodes.

The labeling unit 3044 simultaneously estimates node labels (whether a segment is a part of a flexible object, a hand, a background, etc.) and edge labels (internal relationship of the same object, holding relationship, contact relationship, etc.) using, for example, GNN. When a captured image is a moving image frame, the labeling unit 3044 performs node correspondence between preceding and following frames and also processes temporal relationship changes with GNN or an extended time-series model.

The integration unit 3045 integrates segment groups constituting the same flexible object and assigns labels based on obtained labels and relationship information to determine as a final object.

The estimation unit 3046 estimates a position, a shape (degree of wrinkles, spread), and a posture of an integrated flexible object.

### (Segmentation Processing)

Next, an example of segmentation processing performed by the segmentation unit 3041 will be described.

The segmentation unit 3041 minutely divides (over-divides) an image into regions using a high-precision semantic segmentation model such as U-Net or DeepLab for an image input. A semantic segmentation model is a model that creates a segmentation map of an input image. U-Net is one of FCN (fully convolution network) and is a network for estimating segmentation (where an object is) of an image. DeepLab is a deep learning model that exhibits high performance in an image recognition task called semantic segmentation.

Thereby, the segmentation unit 3041 generates a plurality of segments (micro pixel regions) that cover fine creases, wrinkles, complex contours, etc. of a flexible object without excess and deficiency.

However, at this stage, label assignment is not performed, and it is specialized in purely subdividing an image into segment units. Thereby, in the present embodiment, maximization of “segmentation accuracy” is achieved.

### (Feature Extraction Processing)

Next, an example of processing performed by the feature extraction unit 3042 will be described.

The feature extraction unit 3042 extracts feature amounts such as color, texture, position information, and depth information (as necessary), etc. for each segment using, for example, a feature amount extraction algorithm. A feature amount extraction algorithm may extract feature amounts using a trained model such as CNN (Convolutional neural network), VGG (Visual Geometry Group), or ResNet (Residual Network), etc. Alternatively, the feature extraction unit 3042 may extract feature amounts using a well-known method such as Haar-Like feature amount, HOG (Histograms of Oriented Gradients) feature amount, or SIFT (Scale-Invariant Feature Transform) feature amount, etc.

### (Graph Representation, Labeling Processing)

Next, processing performed by the graph representation generation unit 3043 and an example of labeling processing performed by the labeling unit 3044 will be described.

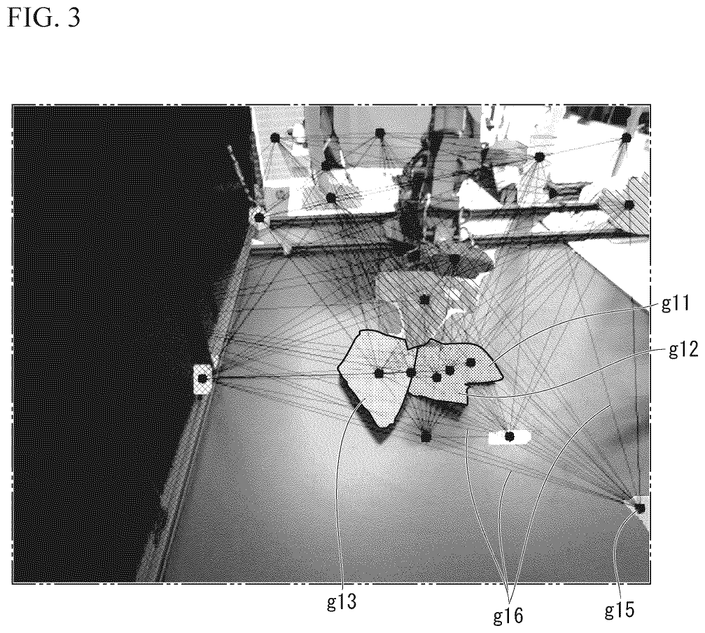

FIG. 3 is a diagram showing an example of a result of performing segmentation processing on an image captured in a state where a handkerchief with creases, etc. exists in a work space and an example of performing labeling processing. In FIG. 3, circles g15 are nodes, and lines g16 are edges.

The graph representation generation unit 3043 forms edges indicating relationships between nodes based on features such as proximity, similarity, positional relationship, and contact relationship, with segments as nodes. The labeling unit 3044 simultaneously estimates node labels (whether a segment is a part of a flexible object, a hand, a background, etc.) and edge labels (internal relationship of the same object, holding relationship, contact relationship, etc.) using, for example, GNN. Relationships include “being a part of the same flexible object”, “a robot hand is holding a flexible object”, “being in contact state although being a different object”, etc., and also include relationships specific to flexible objects.

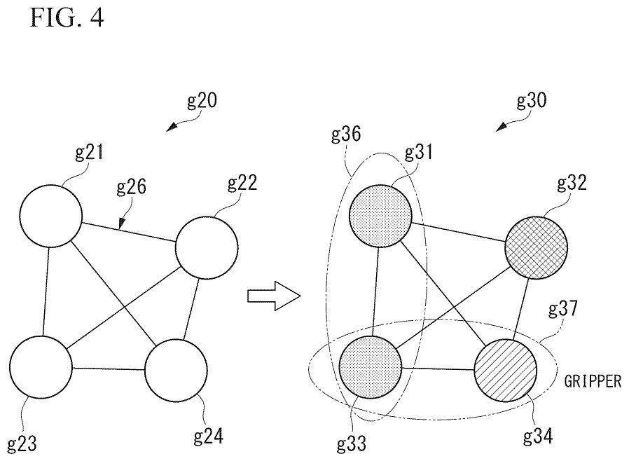

FIG. 4 is a diagram for explaining a graph representation example and a labeling processing example.

An image of reference numeral g20 is a graph representation example after estimating nodes and edges. Circles g21 to g24 are nodes, and lines g26 connecting nodes are edges. At this stage, labeling has not been performed on each node.

An image of reference numeral g30 is an example after labeling. As a result of estimation on the basis of relationships between nodes, this is an example in which nodes g31 and g32 are estimated to be nodes of a flexible object and are estimated to be the same object as in ellipse g36. Node g32 is estimated to be an environmental object (for example, other than a target object or the end effector 4), and node g34 is estimated to be a gripper that is a hand 45 of the end effector 4. As in ellipse g37, this is an example in which nodes g33 and g34 are estimated to be objects being gripped.

### (Integration Processing)

Next, an example of integration processing performed by the integration unit 3045 will be described.

The integration unit 3045 estimates, for example, labels of nodes (segments) (whether they are a part of a flexible object, a hand, a background, etc.) and edges (relationships between segments) by analyzing a graph with GNN. Thereby, according to the present embodiment, it becomes possible to integrate a plurality of divided segments to identify as one flexible object, or to correctly understand a situation where a flexible object and a hand move integrally.

By such processing, the integration unit 3045 integrates segment groups constituting the same flexible object based on obtained labels and relationship information to determine the segment groups as a final object.

### <Configuration Example of Work System Including State Estimation System>

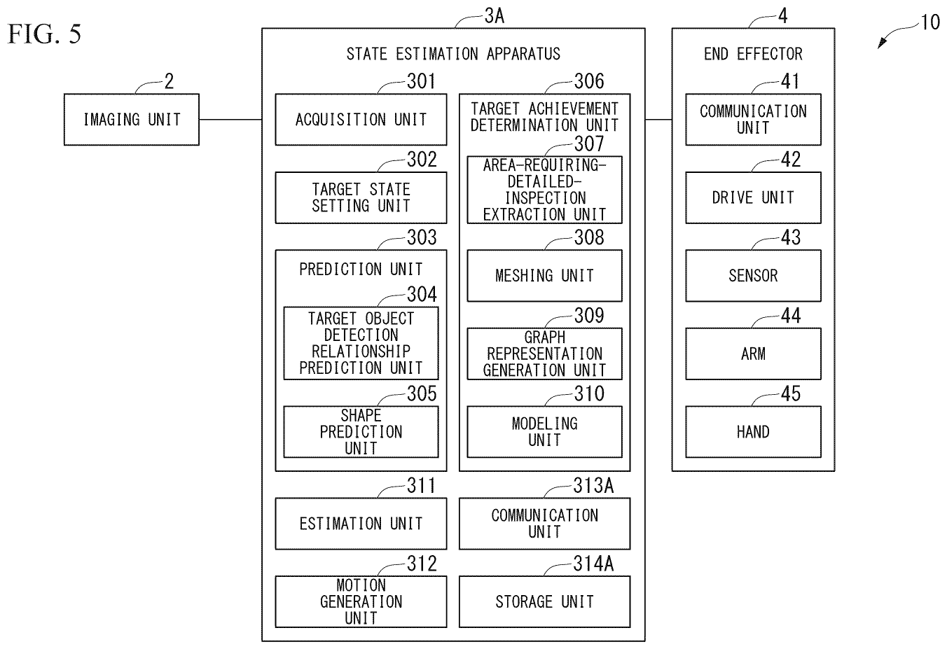

FIG. 5 is a diagram showing a configuration example of a work system including a state estimation system of the present embodiment. A work system 10 includes, for example, an imaging unit 2, a state estimation apparatus 3A, and an end effector 4

The state estimation apparatus 3A includes, for example, an acquisition unit 301, a target state setting unit 302, a prediction unit 303, a target achievement determination unit 306, an estimation unit 311, a motion generation unit 312, a communication unit 313A, and a storage unit 314A.

The end effector 4 includes, for example, a communication unit 41, a drive unit 42, a sensor 43, an arm 44, and a hand 45.

The state estimation apparatus 3A and the imaging unit 2 are connected by wire or wirelessly. The state estimation apparatus 3A and the end effector 4 are connected to each other by wire or wirelessly.

The state estimation apparatus 3A estimates, for example, a range and shape of a first object and a positional relationship with a second object from an image captured by the imaging unit 2, and creates a work plan of the end effector 4.

The motion generation unit 312 calculates a joint angle sequence that reaches a target point with IK (inverse kinematics) on the basis of an estimated shape.

The communication unit 313A acquires detection results detected by the sensor 43 of the end effector 4. The communication unit 313A outputs a motion instruction generated by the motion generation unit 312 to the end effector 4.

The storage unit 314A stores algorithms, formulas, predetermined values, etc. used by each processing unit. The storage unit 314A stores algorithms, constraints, mathematical formulas, predetermined values, etc. necessary for motion generation. The storage unit 314A stores positions where sensors 43 are attached, identification information for identifying each sensor, types of sensors, etc. in association with each other.

The end effector 4 includes, for example, one arm 44 and hand 45.

The communication unit 41 outputs detection results detected by the sensor 43 to the state estimation apparatus 3A. The communication unit 41 acquires operation instructions from the state estimation apparatus 3A.

The drive unit 42 includes, for example, an actuator and a drive circuit, and is attached to, for example, each joint of the arm 44 and hand 45.

The sensor 43 is, for example, a tactile sensor that detects force applied to finger portions and a palm, a force sensor that detects forces in three axes and torque around each axis applied to fingers, a posture sensor that detects joint angles of the arm 44 and joint angles of each finger, etc.

The arm 44 includes a joint. One end of the arm 44 is connected to, for example, a base portion, and hand 45 is connected to the other end via a joint.

The hand 45 includes, for example, two or more finger portions. The hand 45 may include a palm. Each finger portion includes a joint.

### <Stepwise Specification Processing of Target Achievement Determination Portion (Area Requiring Detailed Inspection)>

Next, stepwise specification processing of a target achievement determination portion (area requiring detailed inspection) will be described.

The area-requiring-detailed-inspection extraction unit 307, for example, extracts, as an area requiring detailed inspection, a portion where there is a possibility that a state of a flexible object (first object) has not reached a target state based on two-dimensional image information. This “area requiring detailed inspection” refers to, for example, a critical region where it should be determined in detail whether or not a flexible object is correctly covered on an inflexible object.

In the present embodiment, subsequent three-dimensional detailed analysis is applied only to a portion where an area requiring detailed inspection has been specified (high-precision three-dimensional acquisition to a limited range, not the entire region).

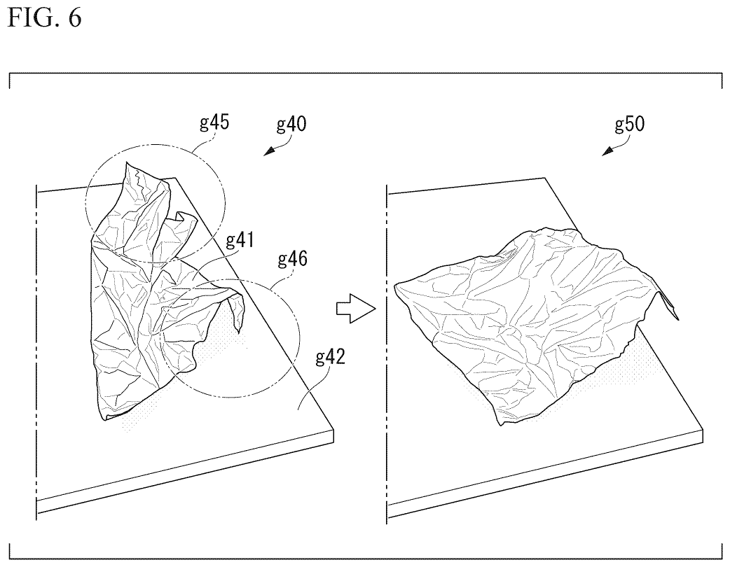

FIG. 6 is a diagram showing an area-requiring-detailed-inspection example and a target state example. The example of FIG. 6 is an example in which work content is, for example, spreading paper g41 with wrinkles on table g42.

Reference numeral g40 is an example of an image captured in a state at the start of work. At the start, paper g41 is in a state where wrinkles and creases have occurred. Ellipse g45 and ellipse g46 are examples of areas requiring detailed inspection, and are examples of regions where a state of paper g41 is difficult to understand from a two-dimensional image and a relationship with table g42 is also difficult to understand.

Reference numeral g50 is an example of an image captured after reaching a target state. The target state is to spread paper g41 on table g42 by stretching wrinkles and creases, but since there is also a risk of tearing if all wrinkles and creases are eliminated, for example, when a predetermined area or thickness is reached, it is determined to be “spread”, and this state is set as a goal.

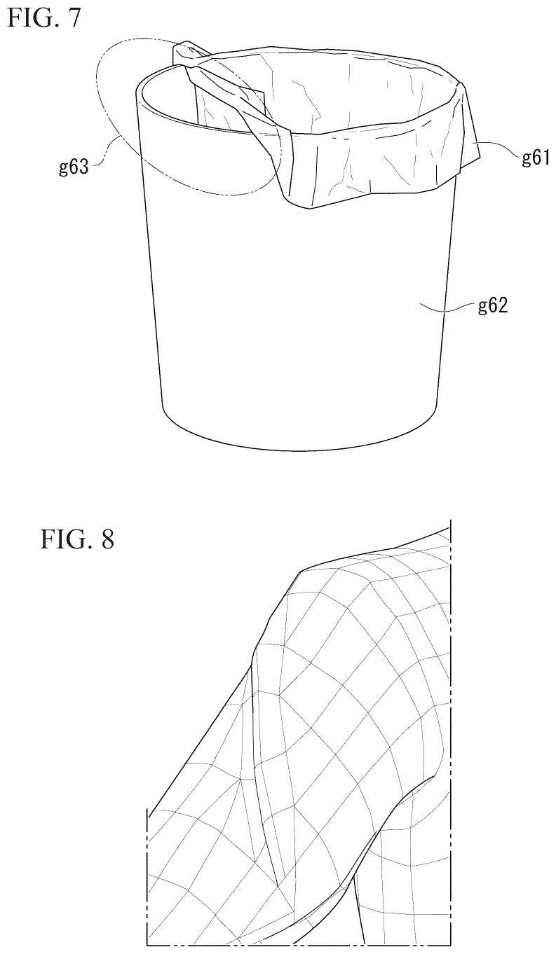

FIG. 7 is a diagram showing another area-requiring-detailed-inspection example.

FIG. 7 is an example in which work content is spreading a vinyl bag (first object) g61 that is a flexible object and covering a rim portion of a plastic bucket (second object) g62 by folding a mouth portion of the vinyl bag. Ellipse g63 is an example of an area requiring detailed inspection, and is an example of a region where a rim portion of plastic bucket g62 is not covered with a vinyl bag.

Work content, target states, and areas requiring detailed inspection described using FIGS. 6 and 7 are examples and are not limited thereto.

### <Three-Dimensional Information Acquisition and Mesh Graph Construction Processing>

Next, three-dimensional information acquisition and mesh graph construction processing will be described.

The acquisition unit 301 acquires high-precision three-dimensional data by a depth camera or a three-dimensional scanner for an area requiring detailed inspection. The meshing unit 308 performs meshing on acquired three-dimensional data.

The graph representation generation unit 309 represents a mesh with nodes and edges, and assigns position embedding (coordinates, curvature, etc.) to nodes and relationship embedding (inter-node distance, directionality, difference in normal direction, etc.) to edges.

FIG. 8 is an image showing an example of meshing an image of a target object having wrinkles.

The meshing unit 308 performs image processing on an acquired image and extracts a contour of a target object. Meshing is shape data in which three-dimensional data is converted into point cloud data and points of the point cloud data are connected as vertices with sides and surfaces, and is, for example, computation processing of a polytope network that linearly approximates and represents a contour region. A polytope is a generalized figure, and for example, polytopes from zero-dimensional to three-dimensional are points, line segments, polygons, and polyhedra, respectively. A mesh is given as a union of polytopes.

The graph representation generation unit 309 sets vertices of polytopes meshed in this way as nodes and sides as edges.

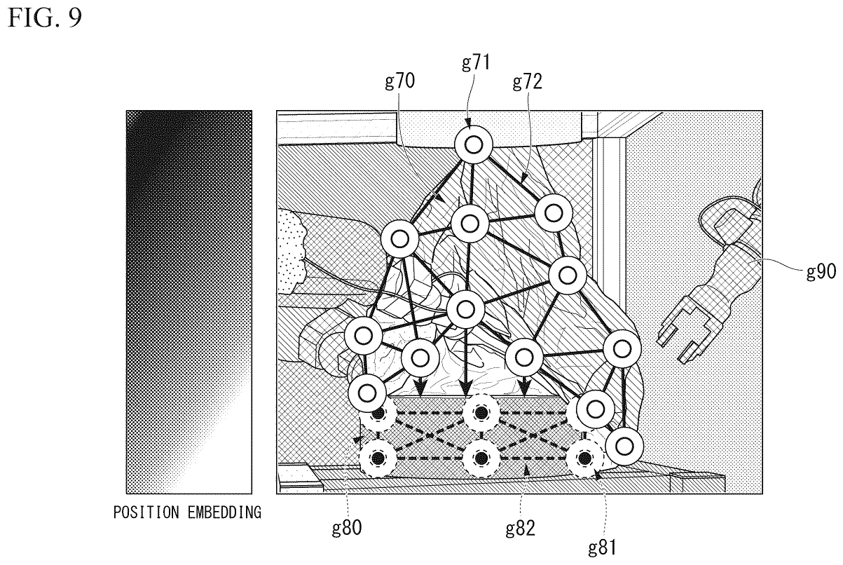

FIG. 9 is a diagram for explaining an example of nodes and edges and an example of assigning position embedding to nodes. FIG. 9 is an example represented by graph representation after passing through a voxel filter. This is an example of processing after increasing a size of a mesh. The mesh is a mesh in Fourier space. FIG. 9 shows these graph representations superimposed on a captured image.

In FIG. 9, reference numeral g70 is a region of an image of a first object, reference numeral g80 is a region of an image of a second object, and reference numeral g90 is a region of an image of end effector 4.

Circles g71 represent nodes of the first object, and lines g72 represent edges of the first object. Circles g81 represent nodes of the second object, and lines g82 represent edges of the second object.

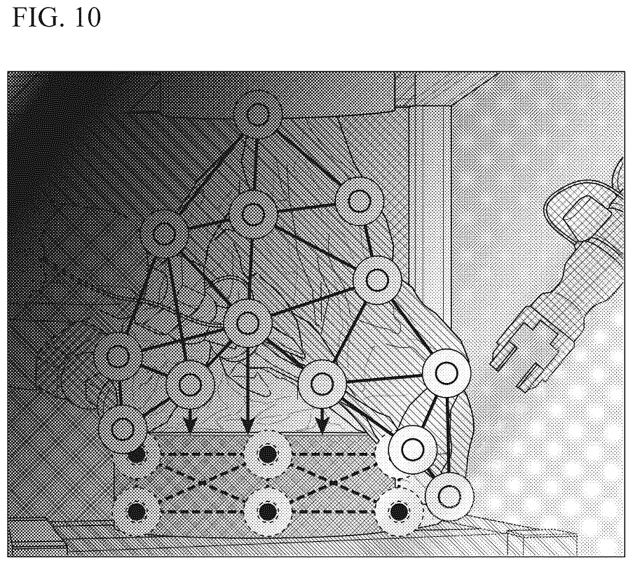

FIG. 10 is an image diagram of an example in which position embedding is assigned to nodes.

Position embedding is a two-dimensional representation, and for example, the upper left is darkest and the lower left is lightest. The gradation represents an image of two-dimensional information like a weight.

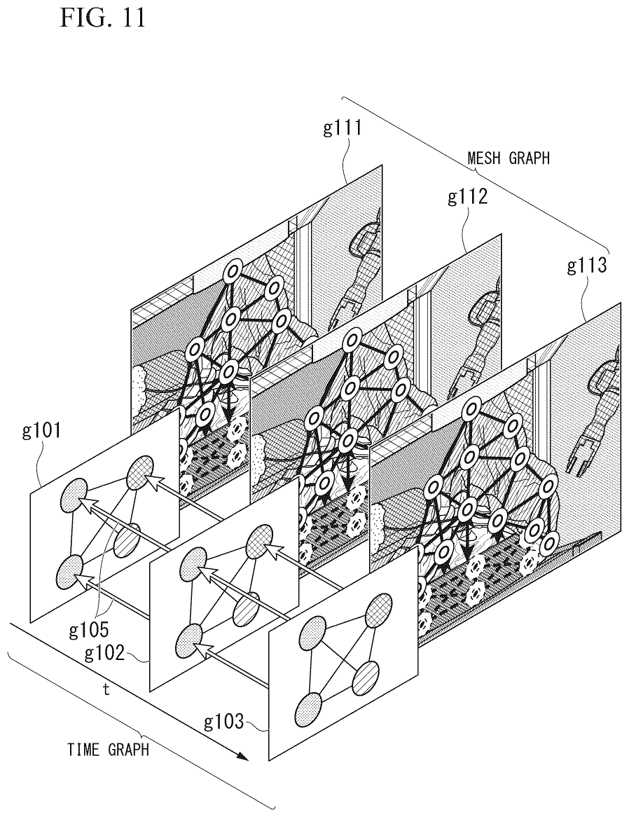

FIG. 11 is a diagram showing a correspondence example between a mesh graph and a time graph.

Images of reference numerals g101 to g103 are time graphs, and a horizontal axis is time (frame). Arrow g105 represents an image of performing node correspondence between preceding and following frames. Images of reference numerals g111 to g113 are mesh graphs.

Thus, in the present embodiment, in a case of moving image frames, node correspondence is performed between preceding and following frames, and temporal relationship changes are also processed with GNN or an extended time-series model. In the present embodiment, when acquired images are continuous images, data that moves together with segment labels and distances between image frames is accumulated and learned, node correspondence is performed in frames, and information with node correspondence is further input into GNN.

### <Node Reduction Processing>

Next, node reduction processing will be described.

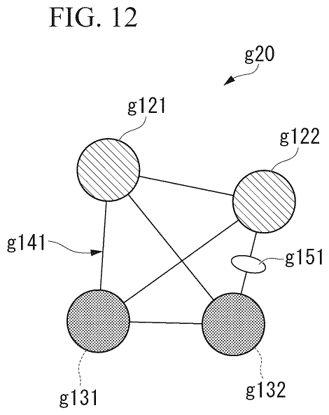

FIG. 12 is a diagram for explaining node reduction processing.

In FIG. 12, circles g121 and g122 are nodes of a first object. Circles g131 and g132 are nodes of a second object. Line g141 is an edge.

Ellipse g151 is an example of an edge to be reduced. The modeling unit 310 reduces the number of nodes by utilizing position and curvature information included in position embedding information on a mesh. In the present embodiment, after being deleted in this way, a target achievement degree between two target objects is calculated using pairs of remaining nodes.

### <Target Achievement Determination>

Next, target achievement determination will be described.

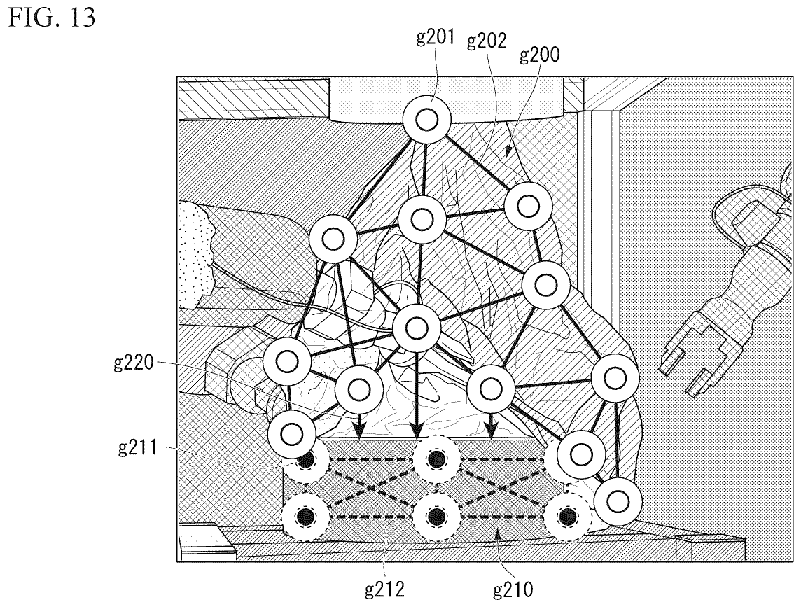

FIG. 13 is a diagram for explaining target achievement determination processing. FIG. 13 is an example represented by graph representation after passing through a voxel filter. This is an example of processing after increasing a size of a mesh. The mesh is a mesh in Fourier space. FIG. 13 shows these graph representations superimposed on a captured image.

Reference numeral g200 indicates a flexible object that is a first object, reference numeral g201 indicates nodes in the first object, and reference numeral g202 indicates edges in the first object.

Reference numeral g210 indicates a rigid body that is a second object, reference numeral g211 indicates nodes in the second object, and reference numeral g212 indicates edges in the second object.

Bidirectional arrow g220 is a relationship between two objects.

As described above, position embedding (coordinates, curvature, etc.) is assigned to the nodes, and relationship embedding (inter-node distance, directionality, difference in normal direction, etc.) is assigned to the edges.

The target achievement determination unit 306 can easily calculate a target achievement degree between two target objects by pairs of nodes by utilizing position and curvature information on a mesh included in position embedding embedded in nodes.

### <Method for Calculating Target AchievementDegree Between Two Target Objects Using Pairs of Nodes>

Here, an example of a method for calculating a target achievement degree between two target objects using pairs of nodes will be described. In calculation of a target achievement degree between two target objects using pairs of nodes, for example, (i) to (v) are performed.

(i) First, in the present embodiment, shape comparison using Chamfer Distance is performed. Chamfer Distance is an index for evaluating a geometric distance between two point clouds P and Q, and is typically defined by the following formula (1), etc.

$${d}_{Chamfer} ( P , Q ) = {\sum }_{p ∈ P} {min}_{q ∈ Q} {‖ p - q ‖}^{2} + {\sum }_{q ∈ Q} {min}_{p ∈ P} {‖ q - p ‖}^{2} \qquad ( 1 )$$

Thereby, according to the present embodiment, deviation between an actual shape (observed shape) of a flexible object and a target shape (a state ideally in close contact with a rigid body surface, etc.) can be comprehensively quantified. According to the present embodiment, since nearness of an entire point cloud can be measured without performing strict correspondence on a node-by-node basis, if there is an uncovered portion or floating, distance increases and a score decreases.

(ii) Next, in the present embodiment, Graph Transformer and inter-node relationships are used.

In the present embodiment, feature amounts (embedding) such as position, curvature, and normal are assigned to each node of a flexible object mesh {p_{flex,i}} and a rigid body mesh {p_{rigid,j}}. In Graph Transformer, “which inter-node relationship is important” is learned by Attention Weight, and subtle distortions and local deviations in shape can also be captured. Thereby, according to the present embodiment, for example, if importance is placed on distance between “an edge portion of a flexible object” and “a rim portion of a rigid body”, whether or not a bag correctly covers an edge can be directly reflected.

(iii) Next, in the present embodiment, time-series prediction using GNN Dynamics is performed. In the present embodiment, a “GNN Dynamics” method that handles temporally continuous frame or scan data on a GNN basis is introduced, and a future state in which a flexible object deforms by receiving external force, gravity, etc. is predicted. Thereby, according to the present embodiment, it is possible to quantitatively evaluate “whether there is a possibility of approaching a target shape by a next robot operation even if there is partial deviation currently”. If necessary, simulation steps are repeated a plurality of times to stepwise determine a degree of convergence to a target shape.

(iv) Next, in the present embodiment, distance/normal evaluation on a node pair basis and “achievement degree” scoring are performed. For all pairs (or subsampling) of a node pair, which is a node p_{flex,i} of a flexible object and a node p_{rigid,j} of a rigid body, distance ∥p_{flex,i}−p_{rigid,j}|, normal vector <n_{flex,i}, n_{rigid,j}>, and curvature difference, etc. are calculated. Then, in the present embodiment, these individual evaluations are integrated by an Attention mechanism or statistical method, and a final achievement degree score is obtained by “what is a ratio that falls within a threshold among all pairs” or “how small is an average value of distances”. Thereby, according to the present embodiment, when there are wrinkles or curling, normal direction differences and distances increase and scores decrease, so problem locations are easily visualized and extracted.

(v) Next, in the present embodiment, application to robot motion planning is performed. In the present embodiment, by utilizing the above achievement degree score and future shape estimation by GNN Dynamics, an optimal motion command (gripping position, pushing angle, stretching direction, etc.) is given to a robot. Thereby, according to the present embodiment, for example, feedback control such as preferentially pulling a portion with a low achievement degree or pushing into a target region becomes possible. According to the present embodiment, a series of motion plans for bringing a flexible object closer to a target shape in shorter steps is automatically generated.

### <Processing Flow of Shape Estimation Apparatus>

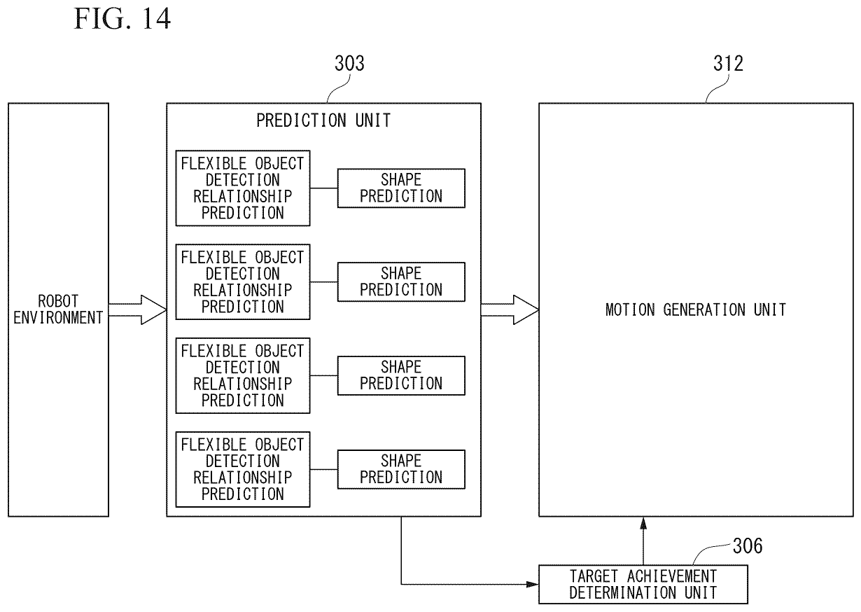

FIG. 14 is a diagram showing an example of a processing flow of a state estimation apparatus of the present embodiment.

First, the target object detection relationship prediction unit 304 predicts detection of a flexible object and relationships with other objects using data acquired from a robot environment.

Next, the shape prediction unit 305 predicts a shape of a flexible object using data output by the target object detection relationship prediction unit 304.

Next, the target achievement determination unit 306 performs target achievement determination by calculating, using pairs of nodes, a target achievement degree between two target objects by utilizing position and curvature information on a mesh, thereby calculating deviation from a target object (reference object).

The motion generation unit 312 inputs output data of the shape prediction unit 305 and output data of the target achievement determination unit 306 into an encoder of Transformer, and calculates a physical target point or direction that an end effector should reach. The motion generation unit 312 may, for example, directly generate a joint angle sequence with a trained decoder, or may calculate on the basis of inverse kinematics.

By causing a robot to execute a trajectory obtained in this way, it leads to actual operation.

### <Processing Procedure of State Estimation Apparatus>

Next, an example of a processing procedure of the state estimation apparatus 3 will be described.

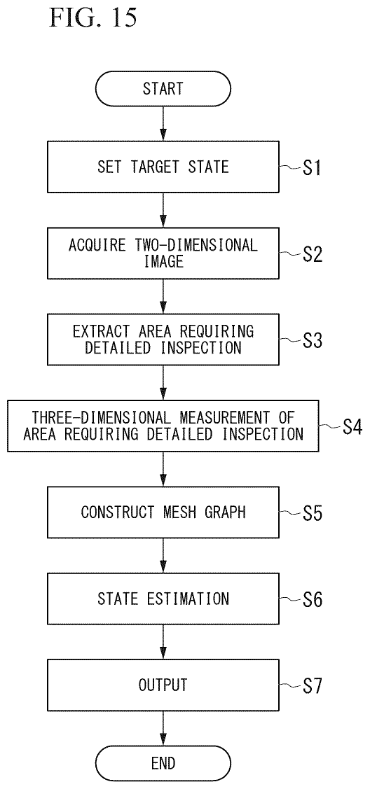

FIG. 15 is a flowchart of processing of a state estimation apparatus of the present embodiment. The following processing is a processing example in the configuration example of FIG. 1.

(Step S1) The target state setting unit 302 sets a target state of a target object.

(Step S2) The acquisition unit 301 acquires two-dimensional image information captured by the imaging unit 2.

(Step S3) The area-requiring-detailed-inspection extraction unit 307 extracts an area requiring detailed inspection in a captured two-dimensional image.

(Step S4) The acquisition unit 301 performs three-dimensional measurement of an area requiring detailed inspection extracted by the area-requiring-detailed-inspection extraction unit 307 and acquires three-dimensional data.

(Step S5) The meshing unit 308 meshes a region of a target object among acquired three-dimensional data. Subsequently, the graph representation generation unit 309 represents a meshed image with nodes and edges. The graph representation generation unit 309 assigns position embedding information (coordinates, curvature, etc.) to nodes and assigns relationship embedding information (inter-node distance, directionality, difference in normal direction, etc.) to edges.

(Step S6) The modeling unit 310 analyzes a mesh graph including an area requiring detailed inspection by, for example, Graph Transformer and spatiotemporal GNN. Thereby, the modeling unit 310 identifies a distance between a first object and a second object and identifies whether or not there is a region that has not reached a target state.

(Step S7) The communication unit 313 outputs a processing result to, for example, an external device.

As in FIG. 5, when the state estimation apparatus 3A controls the end effector 4, using a result obtained in step S6, the motion generation unit 312 generates a motion instruction and controls motion of the end effector 4.

As described above, in the present embodiment, an achievement degree when attaching a flexible object (first object) to a target object (second object) is evaluated with high precision, and a region that has not been reached with respect to a target state is accurately detected. Furthermore, in the present embodiment, target achievement determination is performed in consideration of dynamic deformation of a flexible object through an efficient analysis flow that combines two-dimensional images and three-dimensional data, and a spatial and temporal learning method using a mesh graph.

Thereby, according to the present embodiment, the following effects are obtained.

I. High Precision: According to the present embodiment, by intensively performing high-precision three-dimensional analysis of an area requiring detailed inspection, it becomes possible to accurately evaluate presence and size of an uncovered region.

II. Efficiency and Real-Time Performance: According to the present embodiment, since three-dimensional analysis is intensively performed only on an area requiring detailed inspection extracted from a two-dimensional image without performing three-dimensional measurement on an entire region, computational load can be greatly reduced and real-time processing can be realized.

III. Versatility and Expansion of Application Range: According to the present embodiment, by spatiotemporal GNN and Graph Transformer that can handle various deformations of flexible objects, application becomes easy even under different products and environments.

All or part of functions of the state estimation apparatus 3 (or 3A) in the present invention may be performed by recording a program for realizing all or part of processing performed by the state estimation apparatus 3 (or 3A) on a computer-readable recording medium, causing a computer system to read and execute a program recorded on this recording medium. The “computer system” mentioned herein includes an operating system (OS) or hardware such as peripherals. The “computer system” may include a WWW system including a homepage provision environment (or a homepage display environment). The “computer-readable recording medium” is a portable medium such as a flexible disk, a magneto-optical disc, a ROM, or a CD-ROM or a storage device such as a hard disk incorporated into a computer system. The “computer-readable recording medium” may include a medium that holds a program for a predetermined time such as a volatile memory (RAM) in a computer system serving as a server or a client when the program is transmitted via a network such as the Internet or a communication line such as a telephone line.

Alternatively, some or all of these elements may be realized by hardware (a circuit unit including circuitry) such as large scale integration (LSI), an application-specific integrated circuit (ASIC), a field-programmable gate array (FPGA), a graphics processing unit (GPU) or a system on chip (SOC) or may be cooperatively realized by software and hardware.

The program may be transmitted from a computer system in which the program is stored in a storage device or the like to another computer system via a transmission medium or carrier waves in the transmission medium. Here, the term “transmission medium” that transmits the program refers to a medium having a function of transmitting information such as a network (communication network) such as the Internet or a communication line (communication wire) such as a telephone line. The program may be a program for realizing some of the aforementioned functions. Further, the above-described program may be a program for realizing the above-described functions in combination with programs already recorded on the computer system, that is, a so-called differential file (differential program).

Although an embodiment for implementing the present invention has been described above, the present invention is not limited to the embodiment at all, and various modifications and substitutions can be made within a range not departing from the gist of the present invention.

What is claimed is:

1. A state estimation apparatus for a deformable target object, comprising:
a target state setting unit that sets a target state of the target object;
an acquisition unit that acquires image information representing the target object;
a meshing unit that meshes the image information;
a graph representation generation unit that represents the meshed image with nodes and edges, assigns information relating to positions of the nodes to the nodes, and assigns information indicating relationships between the nodes to the edges;
a modeling unit that inputs information of an entire mesh into a GNN (Graph Neural Network) and models distance dependencies and interactions of the entire mesh with an Attention mechanism; and
an estimation unit that estimates region changes of the target object from time-series changes.

2. The state estimation apparatus according to claim 1, comprising:
an area-requiring-detailed-inspection extraction unit that extracts, as an area requiring detailed inspection, a portion where there is a possibility that a state of the target object has not reached the target state based on two-dimensional image information, wherein
the acquisition unit acquires the two-dimensional image information representing the target object and then acquires three-dimensional data of the area requiring detailed inspection extracted by the area-requiring-detailed-inspection extraction unit, and
the meshing unit performs the meshing on the acquired three-dimensional data.

3. The state estimation apparatus according to claim 1, wherein
the information relating to positions of the nodes is information representing at least one of coordinates and curvature, and
the information indicating relationships between the nodes is information representing at least one of inter-node distance, directionality, and difference in normal direction.

4. The state estimation apparatus according to claim 1, wherein
the modeling unit reduces a number of nodes by utilizing position and curvature information included in the information relating to positions of the nodes on the mesh.

5. The state estimation apparatus according to claim 1, wherein
the graph representation generation unit represents with a graph representation after passing through a voxel filter.

6. A state estimation method for a deformable target object, comprising:
a target state setting step of setting a target state of the target object;
an acquisition step of acquiring image information representing the target object;
a meshing step of meshing the image information;
a graph representation generation step of representing the meshed image with nodes and edges, assigning information relating to positions of the nodes to the nodes, and assigning information indicating relationships between the nodes to the edges;
a modeling step of inputting information of an entire mesh into a GNN (Graph Neural Network) and modeling distance dependencies and interactions of the entire mesh with an Attention mechanism; and
an estimation step of estimating region changes of the target object from time-series changes.
